(19) United States
(12) Patent Application Publication
(10) Pub. No.: US 2013/0234529 A1
(43) Pub. Date: Sep. 12, 2013

(54) WIRELESS POWER TRANSFER APPARATUS AND WIRELESS POWER TRANSFER METHOD

(71) Applicant: HITACHI MAXELL, LTD., Osaka (JP)

(72) Inventors: Yasushi MIYAUCHI, Osaka (JP); Yoshihiro TODAKA, Osaka (JP)

(73) Assignee: HITACHI MAXELL, LTD., Osaka (JP)

(21) Appl. No.: 13/785,131

(22) Filed: Mar. 5, 2013

(30) Foreign Application Priority Data
Mar. 8, 2012 (JP) 2012-051533

(51) Int. Cl. H02J 17/00

(52) U.S. Cl. CPC H02J 17/00
USPC 307/104

(57) ABSTRACT

A power transmitter includes a power transmission coil and a power receiver includes a power receiving coil, thereby transferring power between the coils. A power-transmission auxiliary device includes an auxiliary resonator composed of an auxiliary coil and a resonant capacitance, a resonance control unit, and a linking supporting mechanism for keeping a coil distance between the power receiving coil and the auxiliary coil constant, and forms a power receiving space for disposing the power receiving coil between the power transmission coil and the auxiliary coil. The resonance control unit adjusts a resonant frequency of the auxiliary resonator in accordance with a coil distance between the power transmission coil and the auxiliary coil, optimizing receiving power supplied to the power receiver. A possible power transfer distance is increased, and in a region shorter than the coil distance for a critical coupling state, power can be transferred stably.

### BACKGROUND OF THE INVENTION

1. Field of the Invention

The present invention relates to a wireless power transfer system and a wireless power transfer method of wireless power transfer via a power transmission coil provided in a power transmitter and a power receiving coil provided in a power receiver.

2. Description of Related Art

As methods of wireless power transfer, an electromagnetic induction type (several hundred kHz), electric or magnetic field resonance type using transfer based on LC resonance through electric or magnetic field resonance, a microwave transmission type using radio waves (several GHz), and a laser transmission type using electromagnetic waves (light) in the visible radiation range are known. Among them, the electromagnetic induction type has already been used practically. Although this method is advantageous, for example, in that it can be realized with simple circuitry (a transformer system), it also has the problem of a short power transmission distance.

Therefore, the electric or magnetic field resonance type power transfer methods recently have been attracting attention, because of an ability of a short-distance transfer (up to 2 m). Among them, in the electric field resonance type method, when placing the hand or the like in a transfer path, a dielectric loss is caused, because the human body, which is a dielectric, absorbs energy as heat. In contrast, in the magnetic field resonance type method, the human body hardly absorbs energy and a dielectric loss thus can be avoided. From this viewpoint, the magnetic field resonance type method attracts an increasing attention.

FIG. 10 is a front view schematically showing an example of the configuration of a conventional wireless power transfer system using magnetic field resonance. A power transmitter 1 includes a power transmission coil unit including a combination of a loop coil 3a and a power transmission coil 4a (operating as a resonance coil for transmitting power). A power receiver 2 includes a power receiving coil unit including a combination of a loop coil 3b and a power receiving coil 4b (operating as a resonance coil for receiving power). To the loop coil 3a of the power transmitter 1 is connected a high-frequency power driver 5, which converts the power of an AC power supply (AC 100 V) 6 into high-frequency power capable of being transmitted. As a load to the loop coil 3b of the power receiver 2, for example, a rechargeable battery 8 is connected via a rectifier circuit 7.

The loop coil 3a is a dielectric element that is excited by an electric signal supplied from the high-frequency power driver 5 and transfers the electric signal to the power transmission coil 4a by electromagnetic induction. The power transmission coil 4a generates a magnetic field based on the electric signal that has been output from the loop coil 3a. The magnetic field strength of the power transmission coil 4a is a maximum when the resonant frequency f0=1/{2π(LC)^{1/2}} (L represents the inductance of the power transmission coil 4a on the power transmission side, and C represents the stray capacitance). The power supplied to the power transmission coil 4a is wirelessly transferred to the power receiving coil 4b by magnetic field resonance. The transferred power is transferred from the power receiving coil 4b to the loop coil 3b by electromagnetic induction, rectified by the rectifier circuit 7, and supplied to the rechargeable battery 8. In this case, the resonant frequencies of the power transmission coil 4a and the power receiving coil 4b generally are set to be the same.

Herein, when the distance between the power transmitter 1 and the power receiver 2 varies, the coupling state between the power transmission coil 4a and the power receiving coil 4b varies, and a frequency dependency of power transfer efficiency also changes. For example, when the power transmitter 1 and the power receiver 2 are placed at some distance, and the coupling state therebetween is weak, power transfer efficiency viewed from the high-frequency power driver 5 has unimodal characteristics having one peak, as schematically shown in FIG. 11A. However, when the distance between the power transmitter 1 and the power receiver 2 becomes short to bring the coupling coefficient thereof close to 1, the influence of mutual inductance increases, and power transfer efficiency has a close coupling state exhibiting bimodal characteristics having two peaks (f0L and f0H), as schematically shown in FIG. 11B.

That is, when the power transmission coil 4a and the power receiving coil 4b are brought close to each other, the coupling coefficient is not 0 any more, and the influence of mutual inductance M emerges, with the result that the power transfer efficiency has bimodal characteristics and has two peaks at positions away from original resonant frequency f0. Conversely, when the coupling coefficient is decreased by placing the coils away from each other or the like, two peaks come close to each other, and the power transfer efficiency has unimodal characteristics. When the distance between the coils (coil distance) is further increased to decrease the coupling coefficient, the amount of magnetic flux linkage decreases while the power transfer efficiency maintains unimodal characteristics. Therefore, the amount of power to be transferred decreases, with the result that power transfer is rendered impossible.

As described above, when the power transmission coil 4a and the power receiving coil 4b are brought close to each other, the power transfer efficiency has bimodal characteristics. Therefore, even when power is supplied from the high-frequency power driver 5 at any original frequency, the frequency is not a resonant frequency any more, and transfer power decreases due to a degradation in response. This means that the efficiency of power supply from a power transmission side changes due to the distance between the power transmission coil 4a and the power receiving coil 4b. If a frequency of high-frequency power remains constant in such a situation, high-efficiency power transfer cannot be performed due to a separation from a resonance point.

JP 2011-205757 A discloses a configuration in which maximum power transfer efficiency is obtained at all times in spite of the change in a coil distance. That is, in the configuration disclosed by JP 2011-205757 A, three or more resonant frequencies are present in a maximum coupling state in which a coupling coefficient becomes maximum through use of a plurality of power transmission coils and power receiving coils. The power transmission coils and the power receiving coils are placed so that two or more resonant frequencies successively coincide with a power transmission frequency according to a change in distance between the power transmission coil and the power receiving coil in a usable distance range.

At least three different resonant frequencies are provided, and hence, a band width of a resonating frequency can be enlarged as a whole. As a result, even when the distance between the power transmission coil and the power receiving coil changes to vary three resonant frequencies, the resonant frequencies successively coincide with a power transmission frequency, and hence, transfer efficiency is not degraded.

In the case of the configuration disclosed by JP 2011-205757 A, when the number of the provided resonant frequencies is small, there exists a region in which sufficient power transfer efficiency is not obtained according to a change in distance between the power transmission coil and the power receiving coil. This is determined by the relationship between a change amount of a coil distance and an interval of adjacent resonant frequencies. In order to solve the above-mentioned problem, it is necessary to provide a number of coils, resulting in increase in cost of an apparatus. Further, there is a risk in that various coils may magnetically influence each other to degrade power transfer efficiency.

Further, there also is a problem that a power transmission frequency does not coincide with a self-resonant frequency of a power receiving coil in a critical coupling state, and hence, power transfer efficiency is degraded in a coil distance in which a critical coupling state is obtained.

### SUMMARY OF THE INVENTION

Therefore, with the foregoing in mind, it is an object of the present invention to provide a wireless power transfer apparatus and a wireless power transfer method capable of enlarging a distance in which power can be transferred from a power transmission coil and transferring power stably in accordance with the coil distance in a distance region (bimodal characteristics region) shorter than a coil distance which is to cause a critical coupling state.

A wireless power transfer apparatus of the present invention includes: a power transmitter including a power transmission resonator composed of a power transmission coil and a resonant capacitance; and a power receiver including a power receiving resonator composed of a power receiving coil and a resonant capacitance, thereby transferring power from the power transmitter to the power receiver through an interaction between the power transmission coil and the power receiving coil.

In order to solve the above-mentioned problem, the wireless power transfer device of the present invention further includes: a power-transmission auxiliary device including an auxiliary resonator composed of an auxiliary coil and a resonant capacitance; a resonance control unit for adjusting a resonant frequency of the auxiliary resonator; and a linking supporting mechanism for keeping a coil distance between the power receiving coil and the auxiliary coil constant, wherein the power transmitter and the power-transmission auxiliary device are disposed so as to face each other, forming a power receiving space for disposing the power receiving coil between the power transmission coil and the auxiliary coil, and the resonance control unit adjusts a resonant frequency of the auxiliary resonator in accordance with a coil distance between the power transmission coil and the auxiliary coil in an axial direction, thereby optimizing receiving power supplied to the power receiver.

Further, a wireless power transfer method of the present invention uses: a power transmitter including a power transmission resonator composed of a power transmission coil and a resonant capacitance, and a power receiver including a power receiving resonator composed of a power receiving coil and a resonant capacitance, thereby transferring power from the power transmitter to the power receiver through an interaction between the power transmission coil and the power receiving coil, wherein the method further uses a power-transmission auxiliary device including an auxiliary resonator composed of an auxiliary coil and a resonant capacitance, and the method including: disposing the power-transmission auxiliary device and the power transmitter so as to face each other, forming a power receiving space between the power transmission coil and the auxiliary coil, and performing power transfer with the power receiving coil being disposed in the power receiving space, while keeping a coil distance between the power receiving coil and the auxiliary coil constant, and adjusting a resonant frequency of the auxiliary resonator in accordance with the coil distance between the power transmission coil and the auxiliary coil in an axial direction, thereby optimizing receiving power to be supplied from the power transmitter to the power receiver.

According to the present invention, by providing the power-transmission auxiliary device and transferring power while keeping a distance between the auxiliary coil and the power receiving coil constant, power can be transferred stably in spite of change in the distance between the power transmission coil and the power receiving coil. Further, by adjusting the resonant frequency of the auxiliary resonator in accordance with the distance between the power transmission coil and the auxiliary coil, even in a region (bimodal characteristics region) shorter than the distance between the power transmission coil and the auxiliary coil in which a critical coupling state is to be obtained, power can be transferred stably.

### BRIEF DESCRIPTION OF THE DRAWINGS

FIG. 1 is a schematic cross-sectional view showing a configuration of a wireless power transfer apparatus according to an embodiment of the present invention.

FIG. 2A is a schematic cross-sectional view showing an arrangement of elements for performing a vector network analyzer (VNA) measurement of a power transmission-side resonant system of the wireless power transfer apparatus.

FIG. 2B is a graph showing a response to a resonant frequency f3 of an auxiliary resonator obtained by the VNA measurement performed in the arrangement of FIG. 2A of the power transmission-side resonant system of the wireless power transfer apparatus.

FIGS. 2C(a) to 2C(c) show output waveform charts of responses obtained by the VNA measurement performed in the arrangement of FIG. 2A of the power transmission-side resonant system of the wireless power transfer apparatus: FIG. 2C(a) shows a response to a resonant frequency f3=9 MHz of the auxiliary resonator; FIG. 2C(b) a response to a resonant frequency f3=12.1 MHz; and FIG. 2C(c) a response to a resonant frequency f3=16 MHz.

FIG. 3A is a schematic cross-sectional view showing an arrangement of elements for performing a VNA measurement of the wireless power transfer apparatus.

FIG. 3B is a graph showing a frequency dependency of the power transfer efficiency on the resonant frequency f3 obtained by the VNA measurement performed in the arrangement shown in FIG. 3A of the wireless power transfer apparatus.

FIG. 4 shows the relationship of resonant frequencies ftL and ftH of the power transmission-side resonant system with respect to a setting example of the relationship between respective resonant frequencies f1, f2, and f3 of a power transmission resonator, a power receiving resonator, and an auxiliary resonator of the wireless power transfer apparatus.

FIG. 5A is a schematic cross-sectional view showing an arrangement of elements for transferring power in the wireless power transfer apparatus.

FIG. 5B is a graph showing the relationship of output power P of a rectifier circuit with respect to a distance X between a power transmission coil and a power receiving coil at a coil center in the arrangement shown in FIG. 5A.

FIG. 6 is a schematic cross-sectional view showing an arrangement of elements for measuring output power P of a rectifier circuit by changing a distance Z between a power transmission coil and an auxiliary coil in the wireless power transfer apparatus having the same configuration as that of FIG. 1.

FIG. 7 is a graph showing the relationship of the output power P of the rectifier circuit with respect to the resonant frequency f3 of the auxiliary resonator obtained by a measurement in which a distance “a” between the auxiliary coil and the power receiving coil is set to 5 mm in the arrangement of FIG. 6 of the wireless power transfer apparatus.

FIG. 8 is a graph showing the relationship of a peak value of the output power P of the rectifier circuit with respect to a distance Z between the power transmission coil and the auxiliary coil obtained from the measurement result shown in FIG. 7.

FIG. 9 is a graph showing the relationship of the resonant frequency f3 at which the output power P in each distance Z becomes maximum, with respect to the distance Z between the power transmission coil and the auxiliary coil obtained from the measurement result shown in FIG. 7.

FIG. 10 is a cross-sectional view showing a configuration of a conventional wireless power transfer apparatus.

FIGS. 11A and 11B are schematic diagrams each showing the relationship between the power transfer efficiency and the frequency due to a difference in a coupling state (corresponding to a distance between a power transmission coil and a power receiving coil) in the prior art.

### DETAILED DESCRIPTION OF THE INVENTION

A wireless power transfer apparatus of the present invention takes the following aspects based on the above-mentioned configuration.

That is, the wireless power transfer apparatus of the present invention can be configured so that power is transferred from the power transmitter to the power receiver through magnetic field resonance between the power transmission coil and the power receiving coil.

Further, the resonance control unit can be configured so as to adjust the resonant capacitance of the auxiliary resonator to adjust a resonant frequency of the auxiliary resonator.

Further, the wireless power transfer apparatus of the present invention includes a power detection unit for detecting power transferred to the power receiving device, wherein the resonance control unit is configured so as to adjust the resonant frequency of the auxiliary resonator based on a detection signal of the power detection unit.

Further, the wireless power transfer apparatus of the present invention includes a distance detection unit for detecting the coil distance, wherein the resonance control unit can be configured so as to adjust the resonant frequency of the auxiliary resonator based on a detection signal of the distance detection unit.

Further, in the coil distance in which an electromagnetic coupling state between the power transmission resonator and the auxiliary resonator becomes a close coupling state exhibiting bimodal characteristics, the resonance control unit adjusts a resonant frequency f3 of the auxiliary resonator in a direction in which a resonant frequency ft of a transmission-side resonant system formed by the power transmission resonator and the auxiliary resonator approaches a resonant frequency f2 of the power receiving resonator.

Further, it is preferred that a diameter d1 of the power transmission coil, a diameter d2 of the power receiving coil, and a diameter d3 of the auxiliary coil satisfy the relationship: d1>d2, and d2<d3. Maintaining the relationship is effective for increasing a possible power transfer distance. In particular, it is preferred that the relationship: d1=d3 be satisfied. Thus, a great effect for enhancing transfer efficiency characteristics (enlargement of a power receivable range, etc.) is obtained. Needless to say, the same effect is obtained even when rectangular coils or the like are disposed instead of the circular coils. Further, it is preferred that a center axis of the power transmission coil, a center axis of the auxiliary coil, and a center axis of the power receiving coil be placed coaxially.

Further, the wireless power transfer apparatus of the present invention can be configured so that the power receiving coil and the auxiliary coil are planar coils and are placed on an identical plane with center axes of both the coils being coaxial, and further, a diameter d2 of the power receiving coil and a diameter d3 of the auxiliary coil satisfy the relationship: d2<d3. That is, the auxiliary coil and the power receiving coil may be placed at the same position (distance a=0 mm). In this case, cost can be reduced by molding both the coils integrally through use of planar coils so as to reduce thickness. Even in this case, it is necessary to set the diameter of the auxiliary coil to be larger than that of the power receiving coil.

Further, in the coil distance in which an electromagnetic coupling state between the power transmission resonator and the auxiliary resonator becomes a close coupling state exhibiting bimodal characteristics, a resonant frequency f1 of the power transmission resonator, the resonant frequency f2 of the power receiving resonator, and the resonant frequency f3 of the auxiliary resonator can be set so as to satisfy the relationship: f1=f2<f3, or f3<f1=f2. That is, in the present invention, the resonant frequency f3 of the auxiliary coil is different from the resonant frequency f1 of the power transmission coil and the resonant frequency f2 of the power receiving coil. In particular, when the resonant frequency f3 is maximum, power transfer efficiency can be enhanced.

More preferably, the relationship: f0=f1=f2<f3 is satisfied, where f0 represents a resonant frequency of a high-frequency power driver for supplying power to the power transmission coil. That is, by setting the resonant frequency f0 of the high-frequency power driver to be the same frequency as that of the resonant frequency f2, power transfer efficiency can be enhanced most. It is preferred that the resonant frequency f1 of the power transmission coil be the same as f0.

Hereinafter, the present invention will be described by way of embodiments with reference to the drawings. Note that each embodiment merely illustrates an example for embodying the present invention, and the present invention is not limited thereto.

### Embodiment

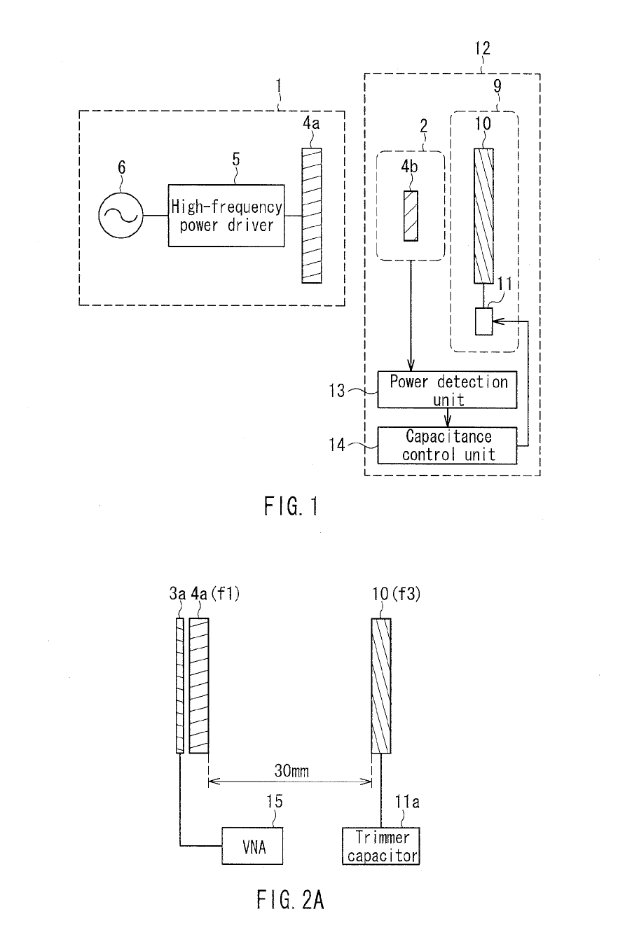

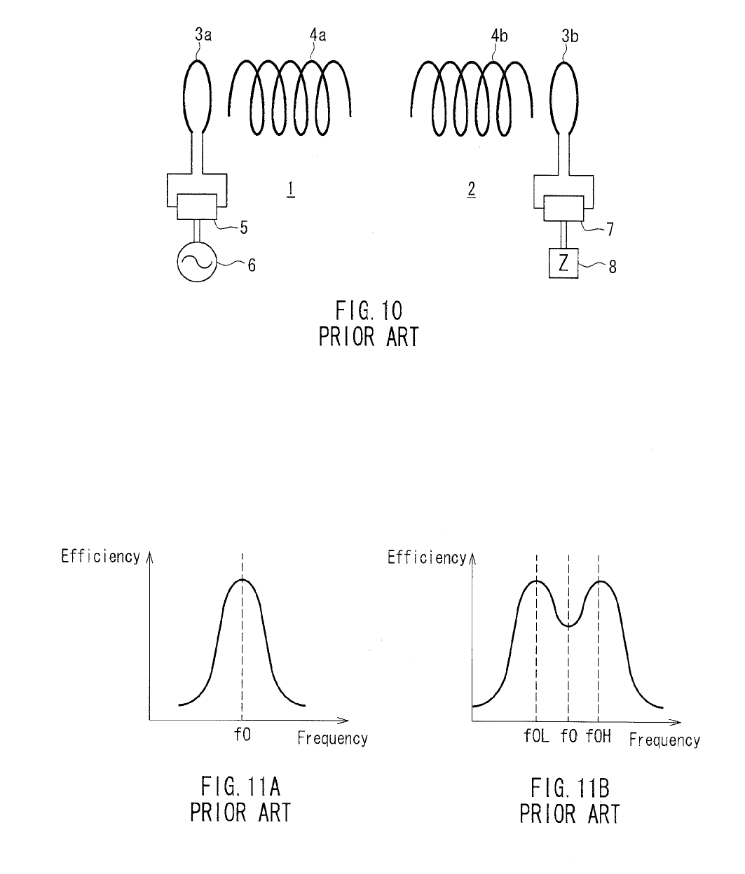

FIG. 1 is a schematic cross-sectional view showing the configuration of a wireless power transfer apparatus of a magnetic field resonance type according to one embodiment. Note that the same elements as those of the conventional wireless power transfer apparatus shown in FIG. 10 are denoted by the same reference numerals, and the description thereof is not repeated.

The wireless power transfer apparatus includes a power-transmission auxiliary device 9 in addition to the power transmitter 1 and the power receiver 2 of conventional technology, and is configured to perform wireless power transfer in a state in which the distance between the power receiver 2 and the power-transmission auxiliary device 9 is kept constant when power is transferred from the power transmitter 1 to the power receiver 2. The power transmitter 1 converts power of an AC power supply (AC 100 V) into high-frequency power capable of being transmitted, and transfer the power, and the power receiver 2 receives the power. The power-transmission auxiliary device 9 has the function of setting the resonant frequency of a resonant system relevant to the power transmitter 1 during power transfer into an appropriate relationship with the resonant frequency of a resonant system of the power receiver 2.

The power transmitter 1 includes at least a power transmission coil 4a, and a high-frequency power driver 5 that converts the power of the AC power supply (AC 100 V) 6 into high-frequency power capable of being transmitted. In some cases, a loop coil for power transmission (see the loop coil 3a of FIG. 10) may be provided. Although not shown, a resonant capacitance is connected to the power transmission coil 4a, thereby forming a power transmission resonator. As the resonant capacitance, a variable capacitor (a variable capacitor, a trimmer capacitor, etc.) or fixed capacitor serving as a circuit element may be connected, or it is possible to adopt a configuration in which a stray capacitance is used. Note that in the following description, the resonant frequency f1 of the power transmission resonator alone is referred to as “the resonant frequency f1 of the power transmitter 1” in order to facilitate understanding of the relationship with the illustration in the drawings.

The power receiver 2 is provided with at least a combination of the power receiving coil 4b and the loop coil (see FIG. 10). The power obtained with the loop coil is stored in a rechargeable battery at least via a rectifier circuit. A resonant capacitance is connected to the power receiving coil 4b, thereby forming a power receiving resonator. As the resonant capacitance, a variable capacitor (a variable capacitor, a trimmer capacitor, etc.) or a fixed capacitor serving as a circuit element may be connected, or it is possible to adopt a configuration in which a stray capacitance is used. Note that in the following description, the resonant frequency f2 of the power receiving resonator alone is referred to as “the resonant frequency f2 of the power receiver 2” in order to facilitate understanding of the relationship with the illustration in the drawings.

The power-transmission auxiliary device 9 includes an auxiliary coil 10 and an adjusting capacitor 11 serving as the resonant capacitance, and the two elements form an auxiliary resonator. Note that in the following description, the resonant frequency f3 of the auxiliary resonator alone is referred to as “the resonant frequency f3 of the power-transmission auxiliary device 9” in order to facilitate understanding of the relationship with the illustrations. As the adjusting capacitor 11, a variable capacitor (a variable capacitor, a trimmer capacitor, etc.) is used so that the capacitance value can be always readjustable.

The above-mentioned resonant system relevant to the power transmitter 1 refers to a resonant system composed of a power transmission resonator including the power transmission coil 4a and an auxiliary resonator including the auxiliary coil 10 formed by coupling between the power transmission coil 4a and the auxiliary coil 10, and is referred to as the “power transmission-side resonant system”. Further, the resonant frequency of the power transmission-side resonant system is referred to as “ft”.

In the present embodiment, as shown in FIG. 1, the power receiving coil 4b of the power receiver 2 and the auxiliary coil 10 of the power-transmission auxiliary device 9 are configured so that the distance therebetween is kept constant by a linking supporting mechanism 12. The linking supporting mechanism 12 may have a configuration of mechanically fixing both the coils to maintain a coil distance, or may have a configuration of supporting both the coils so that only a coil distance is kept without fixing the coils. In this case, it is preferred for obtaining high power transfer efficiency that the power-transmission auxiliary device 9 and the power transmitter 1 be placed so as to face each other.

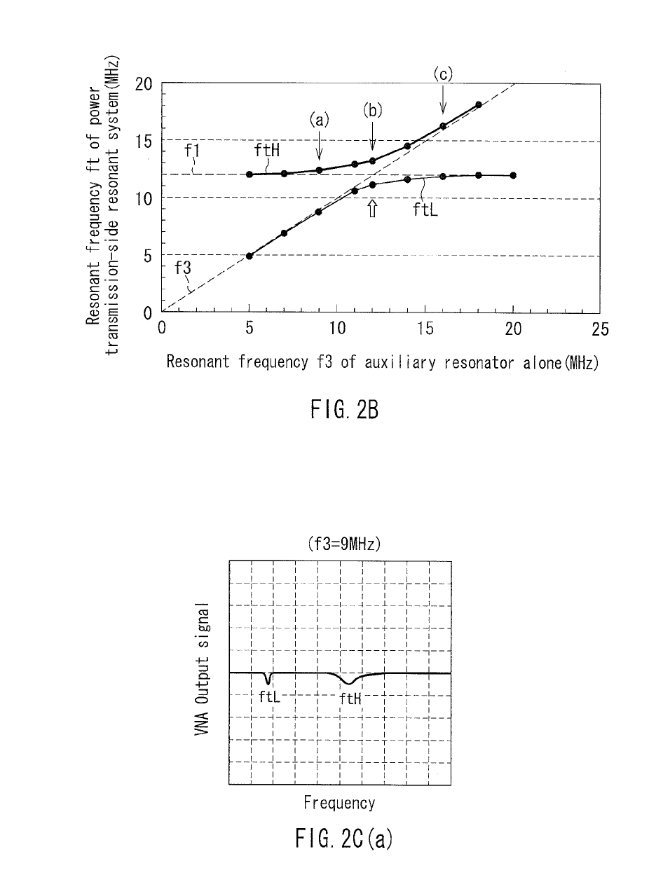

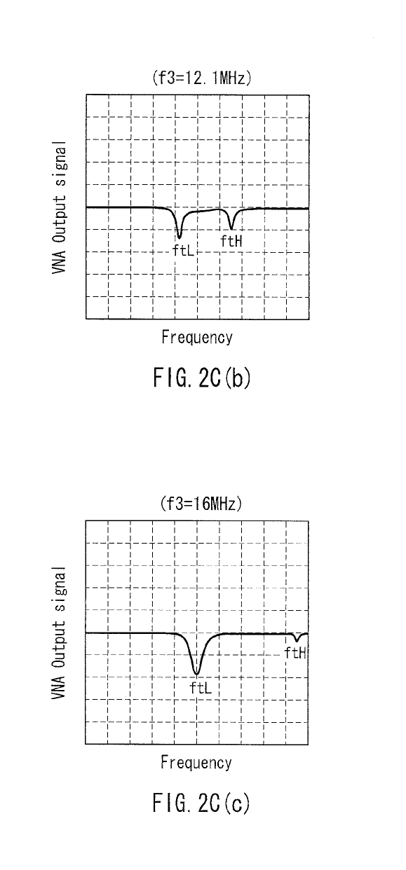

Further, there are provided a power detection unit 13 and a capacitance control unit 14 for coordinating the power receiver 2 and the adjusting capacitor 11. The power detection unit 13 detects a value of power transferred to the power receiver 2. The capacitance control unit 14 performs control to adjust the capacitance of the adjusting capacitor 11 in accordance with the output value of the power detection unit 13. The adjustment of the capacitance of the adjusting capacitor 11 will be described in detail with reference to FIG. 2 and the subsequent figures.

The capacitance of the adjusting capacitor 11 is adjusted so as to adjust a resonant frequency of the auxiliary resonator to optimize receiving power supplied from the power transmitter 1 to the power receiver 2, when the auxiliary coil 10 moves in an axial direction of the power transmission coil 4a. That is, the power detection unit 13 is used for indirectly detecting a change in distance between the coils based on the value of power transferred to the power receiver 2.

Thus, it also is possible to use a distance detection device for detecting a distance between the power transmission coil 4a and the auxiliary coil 10 or the power receiving coil 4b, instead of the power detection unit 13. That is, the capacitance control unit 14 adjusts a capacitance of the adjusting capacitor 11 so as to adjust a resonant frequency of the auxiliary resonator in accordance with a change in distance detected by the distance detecting device. Although not shown, any device such as an optical distance-measuring device, a distance-measuring device using image recognition, and the like may be used as the distance detection unit.

A method for adjusting a resonant frequency of the auxiliary resonator is not limited to the method for adjusting a capacitance of the adjusting capacitor 11. That is, it also is possible to perform control to adjust a resonant frequency of the auxiliary resonator by a resonance control unit based on another method, instead of the capacitance control unit 14.

Further, although not shown, the power-transmission auxiliary device 9 may include, as needed, means for monitoring, for example, the reflected power, the resonant frequency, the flowing current, or the voltage of the power transmission coil 4a, and a circuit or the like for allowing the power transmitter 1, the power receiver 2, and the power-transmission auxiliary device 9 to exchange information with each other. In the case of adopting such a configuration, it also is possible to adopt a configuration in which a capacitance value of the adjusting capacitor 11 is controlled in accordance with the information sent from the power transmitter 1.

Next, the function of the power-transmission auxiliary device 9 constituting the feature of the present embodiment will be described in further detail. With the configuration of the wireless power transfer apparatus shown in FIG. 1, it is possible to achieve effects such as an increased possible power transfer distance and so on as will be described below, compared to a configuration that is not provided with the power-transmission auxiliary device 9. The reason for this seems to be that the reaching distance of the magnetic flux from the power transmission coil 4a is increased by disposing the auxiliary coil 10 so as to face the power transmission coil 4a.

On the other hand, in the configuration as shown in FIG. 1, the resonant frequency of the power transmitter 1 is different from the initially set resonant frequency f1 of the power transmission resonator alone, under a magnetic influence of the auxiliary coil 10. However, the resonant frequency ft of the power transmission-side resonant system can be caused to coincide with the resonant frequency f2 of the power receiver 2 by appropriately setting the resonant frequency f3 of the power-transmission auxiliary device 9 by adjusting the capacitance value C of the adjusting capacitor 11 that is connected to the auxiliary coil 10. This enables the power transfer efficiency of transferring power from the power transmission coil 4a to be maintained at a practically sufficient level, thus achieving effects such as an increased possible power transfer distance and so on.

Although it is desirable that the capacitance value C of the adjusting capacitor 11 be set such that the resonant frequency ft coincides with the resonant frequency f2, an appropriate effect can be achieved even if the two frequencies do not coincide completely with each other. That is, it is appropriate that the resonant frequency f3 of the power-transmission auxiliary device 9 is set such that the peak of the resonant frequency ft of the power transmission-side resonant system is brought closer to the resonant frequency f2 of the power receiver 2, compared to the resonant frequency f1 of the power transmitter 1. To obtain sufficiently an effect achieved by such adjustment, it is desirable that the shape of the auxiliary coil 10 constituting the power-transmission auxiliary device 9 be substantially the same as the shape of the power transmission coil 4a, and that the central axes of the two coils are disposed substantially coaxially.

Further, an effect such as an increased possible power transfer distance can be achieved appropriately if the relationship d1>d2, and d2<d3 is satisfied where d1 is the diameter of the power transmission coil 4a, d2 is the diameter of the power receiving coil 4b, and d3 is the diameter of the auxiliary coil 10. The reason for this is that if the diameter d1 of the power transmission coil 4a is greater than the diameter d2 of the power receiving coil 4b, the magnetic flux between the power receiving coil 4b and the auxiliary coil 10 can be utilized, and if the diameter d3 of the auxiliary coil 10 is greater than the diameter d2 of the power receiving coil 4b, the magnetic flux between the power receiving coil 4b and the power transmission coil 4a can be utilized.

Here, in order to examine the influence of the auxiliary coil 10, a description will now be given of results of performing a vector network analyzer (VNA) measurement using micro power. The resonant frequency f1 of the power transmitter 1 and the resonant frequency f2 of the power receiver 2 are set by the capacitance values of respective fixed capacitors provided as the resonant capacitances. Specifically, they are set such that f1=f2=12.1 MHz.

First, results of examining the change in the resonant frequency of the power transmission-side resonant system when the resonant frequency f3 of the power-transmission auxiliary device 9 was changed are shown. FIG. 2A shows an example of the arrangement of the coils. More specifically, the power transmission coil 4a and the auxiliary coil 10 are disposed so as to face each other, thereby forming a power receiving space having a length of 30 mm, and a VNA 15 is connected to the loop coil 3a. A trimmer capacitor 11a serving as the adjusting capacitor is connected to the auxiliary coil 10, and the resonant frequency f3 was set to be variable.

FIG. 2B shows the results of the VNA measurement in this arrangement. In FIG. 2B, the horizontal axis represents the value of the resonant frequency (resonant frequency of the auxiliary resonator alone) f3 of the power-transmission auxiliary device 9, and the vertical axis represents the value of the resonant frequency ft of the power transmission-side resonant system obtained by the VNA measurement. FIGS. 2C(a) to 2C(c) show output waveform charts for the VNA measurement in the cases where the resonant frequency f3 is 9 MHz (a), 12.1 MHz (b), and 16 MHz (c), respectively.

For example, when f3 is adjusted to the same resonant frequency as f1 (12.1 MHz), two resonant frequencies centered about 12.1 MHz appear (close coupling: bimodal characteristics) as shown in the waveform chart of FIG. 2C(b). The lower resonant frequency on the left is referred to as “ftL”, and the higher resonant frequency on the right is referred to as “ftH”. In FIG. 2B, a characteristic line corresponding to the lower resonant frequency ftL and a characteristic line corresponding to the higher resonant frequency ftH are illustrated. In the present invention, the effect obtained under the condition of bimodal characteristics is large.

As the resonant frequency f3 of the auxiliary resonator alone is changed from the state shown in FIG. 2C(b) to the higher frequency side (20 MHz), the lower resonant frequency ftL gradually shifts to the higher frequency side, as shown in FIG. 2B. The resonant frequency ftL eventually is brought close to 12.1 MHz, which is equal to f1 and f2, and the signal amplitude also increases as shown in FIG. 2C(c). The higher resonant frequency ftH also gradually shifts to the higher frequency side, and the output signal amplitude decreases and approaches zero.

On the other hand, as the resonant frequency f3 is changed from the state shown in FIG. 2C(b) to the lower frequency side (5 MHz), the higher resonant frequency ftH gradually shifts to the lower frequency side, as shown in FIG. 2B, and eventually is brought close to 12.1 MHz, which is equal to f1. However, as shown in FIG. 2C(a), the signal amplitude does not significantly increase, as compared with the resonant frequency ftL changed to the higher frequency side. The lower resonant frequency ftL also gradually shifts to the lower frequency side, and the signal decreases and approaches zero.

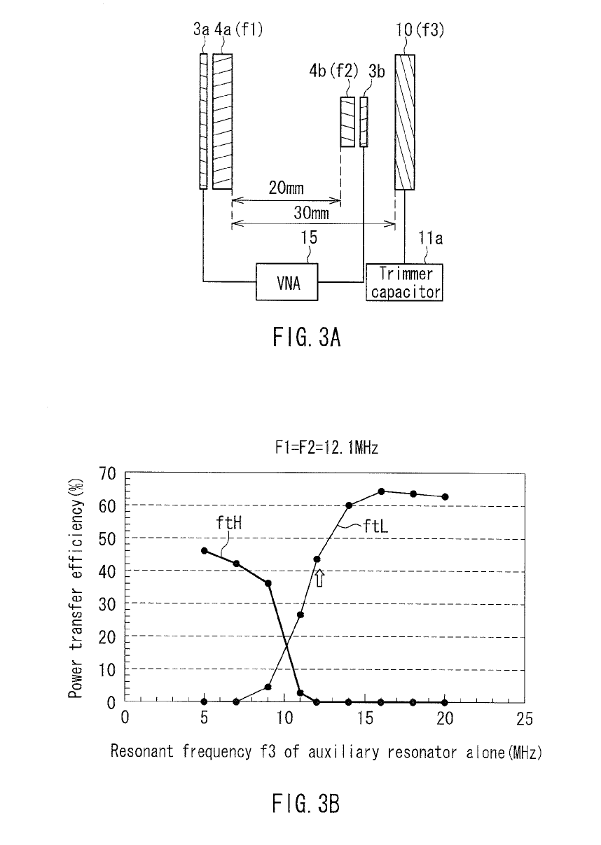

Next, a description will be given of results of examining the change in the power transfer efficiency when the coils were disposed as shown in FIG. 3A and the resonant frequency f3 of the power-transmission auxiliary device 9 was changed. The arrangement in FIG. 3A is configured by disposing the power receiving coil 4b and the loop coil 3b in the power receiving space between the power transmission coil 4a and the auxiliary coil 10 in the arrangement of FIG. 2A. The VNA 15 was connected to the loop coils 3a and 3b. Note that the power transfer efficiency as used herein refers to a value of power transfer efficiency between the power transmission coil 4a and the power receiving coil 4b, and does not include the efficiency of the circuit and the like.

FIG. 3B shows results of the VNA measurement in this arrangement. In FIG. 3B as well, a characteristic line corresponding to the lower resonant frequency ftL and a characteristic line corresponding to the higher resonant frequency ftH are illustrated. As can be seen from FIG. 3B, for example, when f1=f2=f3=12.1 MHz (indicated by the arrow), the power transfer efficiency corresponding to the resonant frequency ftL is as small as about 44%. As f3 is increased further, the power transfer efficiency corresponding to the lower resonant frequency ftL increases. When f3=16 MHz, a power transfer efficiency of about 64% can be obtained.

As described above, increasing the resonant frequency f3 of the power-transmission auxiliary device 9 to be greater than f1 and f2 causes the resonant frequency ft for power transfer to be brought closer to the resonant frequency f2, thereby increasing the power transfer efficiency at that time.

On the other hand, as the resonant frequency f3 is changed to the low frequency side, the power transfer efficiency corresponding to the higher resonant frequency ftH increases. When f3=5 MHz, a power transfer efficiency of about 46% can be obtained. However, the value in the maximum region of the power transfer efficiency corresponding to the higher resonant frequency ftH is smaller than the value in the maximum region of the power transfer efficiency corresponding to the lower resonant frequency ftL.

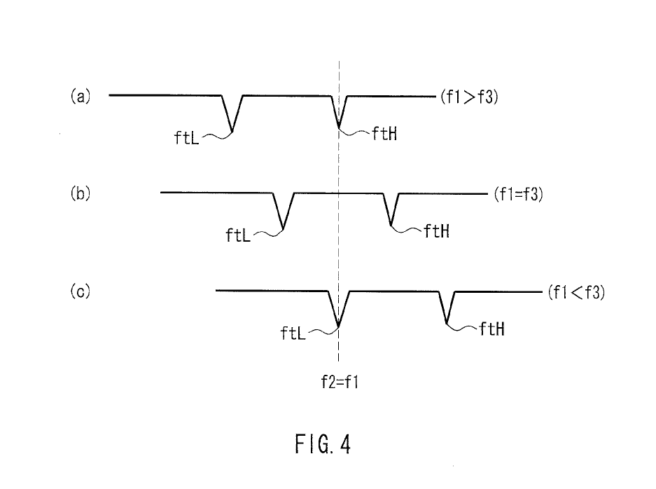

FIG. 4 shows the relationship of the resonant frequency ft of the transmission-side resonant system with respect to the setting examples of the relationship between respective resonant frequencies f1, f2, and f3. FIG. 4 shows a case where the relationship is set such that f1=f2. In this case, as shown in (a), it is possible to cause ftH to coincide with f2 or cause ftH to be sufficiently close to f2 by appropriately setting f3 within the range of f1>f3. To cause ftH to be sufficiently close to f2 means bringing the resonant frequency ft into a state in which ft is close to f2 to the extent that obtained power transfer efficiency is practically equal to that obtained when the resonant frequency ft coincides with the resonant frequency f2. In the following description, the resonant frequency ft that coincides with the resonant frequency f2 includes a resonant frequency ft that is sufficiently close to the resonant frequency f2.

FIG. 4(b) shows a case where ft does not coincide with f2 since the relationship is set such that f1=f2=f3 as described above. By appropriately setting f3 within the range of f1<f3 as shown in (c), it is possible to cause ftL to coincide with f2.

As described above, if the resonant frequency f3 of the power-transmission auxiliary device 9 is different from the resonant frequency f2 of the power receiver 2 (f3≠f2), it is possible to achieve an appropriate effect of causing the resonant frequency ft of the power transmission-side resonant system to coincide with the resonant frequency f2. Note, however, that it is preferable that the relationship f3>f2 be satisfied. Further, in order to enhance power transfer efficiency, the resonant frequency f0 of the high-frequency power driver 5 is set so as to satisfy preferably f0=f2, more preferably f0=f1=f2<f3.

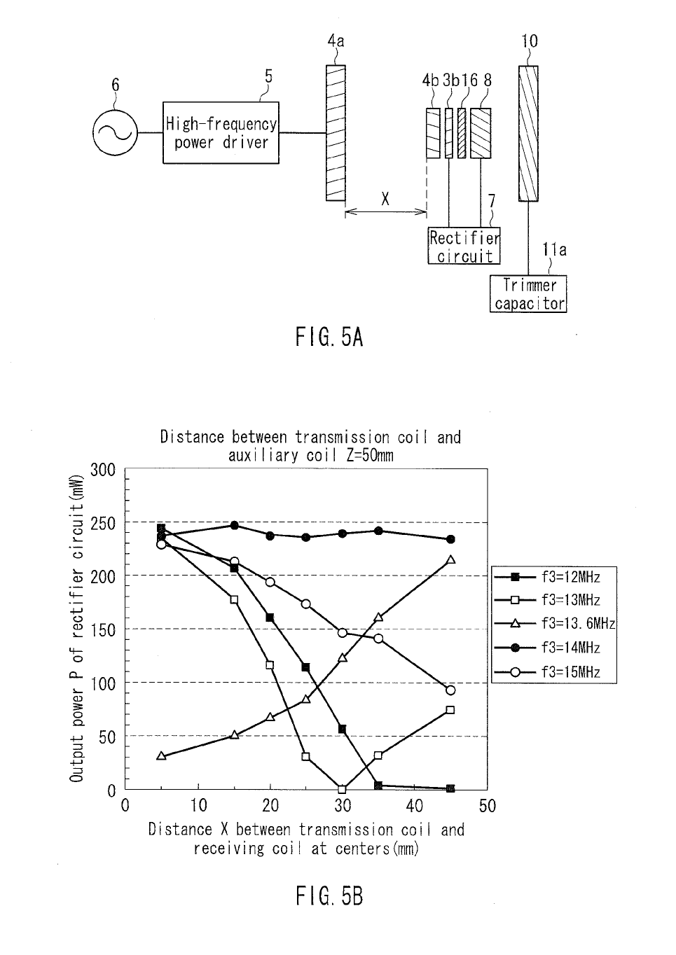

Next, the results of examining the characteristics of power transfer will be described regarding an actual case of the power receiver 2 including the rechargeable battery 8. FIG. 5A is a schematic cross-sectional view showing an arrangement of elements for transferring power. This figure shows a case where the power transmission coil unit includes only the power transmission coil 4a. As needed, the loop coil 3a for transmitting power may be provided. As the power receiving coil unit, a combination of the power receiving coil 4b and the loop coil 3b is disposed. The rechargeable battery 8 is charged with the power obtained by the loop coil 3b at least via the rectifier circuit 7.

In the case of using a small battery (e.g., a thin coin battery) as the rechargeable battery 8, it is preferable to reduce the installation area by overlapping the loop coil 3b and the rechargeable battery 8 with each other (e.g., a coil-on battery). In this case, a magnetic flux may be leaked from the loop coil 3b to the rechargeable battery 8 and generates an eddy current, which results in a loss (eddy-current loss). Therefore, it is desirable that a wave absorber 16 having a high magnetic permeability at the resonant frequency for the power transfer be disposed between the loop coil 3b and the rechargeable battery 8. In this case, the loop coil 3b and the rechargeable battery 8 may be brought into close contact with each other with the wave absorber 16 sandwiched therebetween, in order to reduce the total thickness. It is preferred that the wave absorber 16 be disposed on the rear side of the loop coil 3b even when the rechargeable battery 8 is not integrated with the loop coil 3b, because power transfer efficiency is enhanced.

In the present embodiment, the power transmission coil 4a of the power transmitter 1 has the same function as that of its counterpart shown in FIG. 10. However, the power transmission coil 4a is formed of a planar coil obtained by spirally winding a Cu coil (with coating) having a diameter of about 1 mm on the same plane in order to realize a reduced thickness. Furthermore, the loop coil 3b and the power receiving coil 4b of the power receiver 2 have the same function as that of their counterparts shown in FIG. 10, but they are formed of a thin-film coil obtained by forming, in a spiral form, a Cu foil having a thickness of about 70 μm on the same plane on a thin printed-circuit board having a thickness of 0.4 mm, in order to realize a reduced size. The shape of the power transmission coil, the auxiliary coil, or the power receiving coil may be changed in accordance with required power to be transferred. In the case where power of several kW is required as in an electric vehicle, the diameter of the power transmission coil 4a may be set to 20 cm or more. Further, it is possible to employ an appropriate winding form of a coil such as peripheral close coiling (air core coil) or sparse coiling from an outer periphery to a center portion in accordance with the purpose.

FIG. 5B is a graph showing the relationship of output power P of the rectifier circuit 7 with respect to a distance X between the power transmission coil 4a and the power receiving coil 4b at a coil center, obtained by measurement using the arrangement shown in FIG. 5A. An intrinsic resonant frequency of the power transmission coil 4a was set to 13.6 MHz, and that of the power receiving coil 4b was set to 13.6 MHz. A distance Z between the power transmission coil 4a and the auxiliary coil 10 at the coil center was fixed at 50 mm. In order to check a change in the output power P in accordance with the position of the power receiving coil 4b, the power receiving coil 4b was moved within a power receiving space to change a distance X between the power transmission coil 4a and the power receiving coil 4b at the coil center. Further, a capacitance value of the trimmer capacitor 11a (adjusting capacitor 11) connected to the auxiliary coil 10 was changed to set the resonant frequency f3 of the power-transmission auxiliary device 9 to 12 MHz, 13 MHz, 13.6 MHz, 14 MHz, and 15 MHz, respectively, and measurement was performed for each f3.

It is understood from the above-mentioned result that, when the resonant frequency f3 is 13 MHz, the output power P of the rectifier circuit 7 becomes lowest when the power receiving coil 4b is positioned at the distance X of about 30 mm. Further, it is understood that, when the resonant frequency f3 is 15 MHz, the output power P of the rectifier circuit 7 decreases as the distance X increases. Further, it is understood that, when the resonant frequency f3 is at a resonant frequency (13.6 MHz) close to the resonant frequency f0 (13.56 MHz) of the high-frequency power driver 5, the output power P of the rectifier circuit 7 becomes smallest in a region where the distance X is small, and the output power P of the rectifier circuit 7 increases as the distance X increases further.

Further, when the resonant frequency f3 is 14 MHz, the output power P of the rectifier circuit 7 remains high to give a uniform value as long as the power receiving coil 4b is present in the power receiving space. That is, when the distance Z between the power transmission coil 4a and the power receiving coil 4b is constant, stable receiving power is obtained even when the position of the power receiving coil 4b changes, by setting the resonant frequency f3 of the power-transmission auxiliary device 9 to an appropriate value. Thus, it is understood that, by appropriately selecting the resonant frequency f3 of the power-transmission auxiliary device 9, the power transfer state in the power receiving space can be controlled.

In actual life, the distance Z between the power transmission coil 4a and the power receiving coil 4b is not always constant, and it is assumed that the distance Z may change in some cases. Even in such cases, by adjusting the adjusting capacitor 11 attached to the auxiliary coil 10 to set the resonant frequency f3 to be optimum at each distance Z, power can be transferred stably to the power receiving coil 4b irrespective of the distance X between the power transmission coil 4a and the power receiving coil 4b.

However, it is cumbersome to determine the optimum resonant frequency f3 for stably transferring power to the power receiving coil 4b irrespective of the distance X every time the distance Z changes. Then, in the present embodiment, the resonant frequency f3 at which the output power P of the rectifier circuit 7 becomes maximum is determined so as to correspond to only the position where the power receiving coil 4b is present. This is equivalent to the case where the optimum resonant frequency f3 is determined so as to correspond to the distance Z, if the distance between the centers of the power receiving coil 4b and the auxiliary coil 10 is kept constant. Then, the power transmitter 1 was brought close to the power-transmission auxiliary device 9 to set the distance (hereinafter, referred to as “distance a”) between the centers of the power receiving coil 4b and the auxiliary coil 10 to be constant. Under this condition, a power transfer experiment was conducted. The resonant frequency f2 of the power receiver 2 was fixed at any value (for example, 13.56 MHz which is the same as that of f0). The same applies to the subsequent experiments.

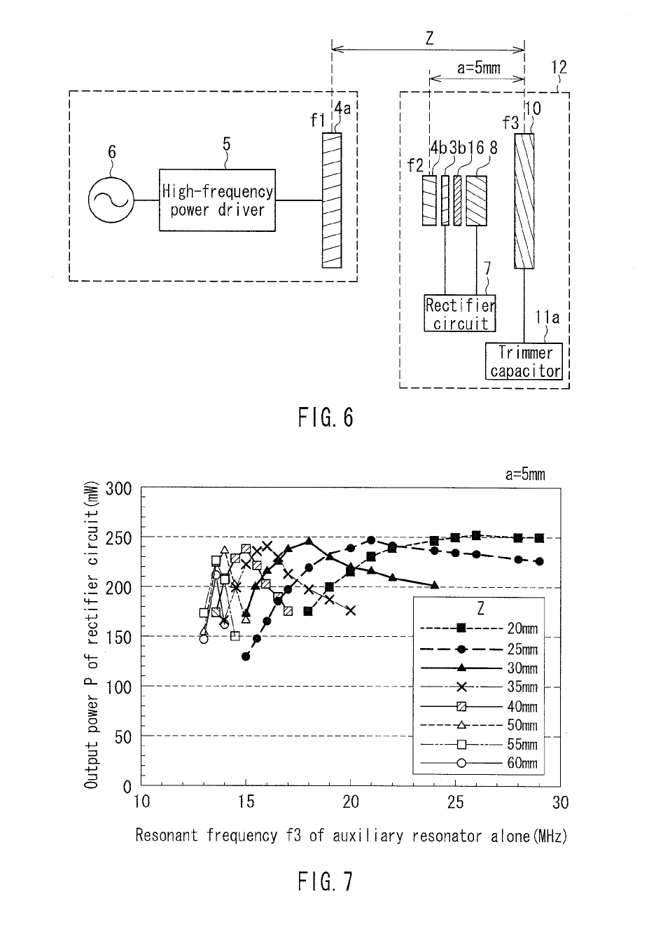

FIG. 6 shows a configuration of a wireless power transfer apparatus used in the experiments. The constituent elements shown in FIG. 6 are the same as those shown in FIG. 5A except that the distance between the power receiving coil 4b and the auxiliary coil 10 is kept constant by the linking supporting mechanism 12. Further, assuming that power is transferred under the condition that the distance X between the power transmission coil 4a and the power receiving coil 4b is larger than the distance a between the power receiving coil 4b and the auxiliary coil 10 (for example, supply of power to an electric automobile, etc.), the characteristics in the case of the small distance a were checked.

The distance a between the power receiving coil 4b and the auxiliary coil 10 was maintained to be 5 mm (the distance a remains unchanged even when the distance Z changes). In the present experiment, the linking supporting mechanism 12 was configured in such a manner that coils were mechanically fixed with a tape. Practically, the linking supporting mechanism 12 can adopt a configuration in which the power receiving coil 4b and the auxiliary coil 10 are directly fixed so as not to move mechanically, a configuration in which only the distance between the power receiving coil 4b and the auxiliary coil 10 is fixed through use of separate fixing jigs, or the like. The distance Z was set to any interval in a range of 20 mm to 60 mm, and a value of the output power P of the rectifier circuit 7 in the case of changing the resonant frequency f3 was measured for each distance Z.

FIG. 7 is a graph showing the relationship of the output power P of the rectifier circuit 7 with respect to the resonant frequency f3, obtained by a measurement in the arrangement of FIG. 6 (the distance Z being changed as a parameter). It is understood from this result that there exists the resonant frequency f3 at which the output power P becomes maximum corresponding to each distance Z, and the margin of the resonant frequency f3 of the output power is larger as the distance Z is smaller. For example, when the distance Z is 30 mm, it is appropriate that the resonant frequency f3 is set between 15.5 MHz and 24 MHz (margin: about 8.5 MHz) in order to obtain the output power P of 200 mW. In contrast, when the distance Z is 40 mm, it is necessary to set the resonant frequency f3 between 13.5 MHz and 16 MHz (margin: 2.5 MHz) in order to obtain the output power P of 200 mW.

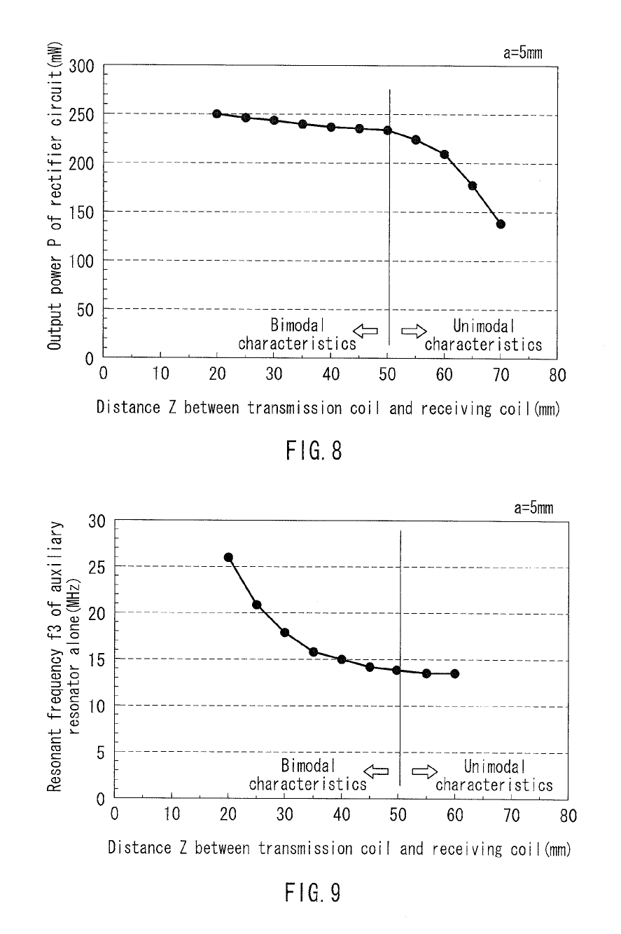

FIG. 8 is a graph obtained by plotting, for each distance Z, a measurement value of the output power P when the output power P of the rectifier circuit 7 becomes maximum from the result of FIG. 7. As shown in FIG. 8, the peak value of the output power P of the rectifier circuit at each distance Z has unimodal characteristics and decreases, when the distance Z increases beyond about 50 mm at which a critical coupling state is obtained.

In contrast, when the distance Z becomes smaller than about 50 mm where the critical coupling state is obtained, the peak value of the output power P of the rectifier circuit 7 has bimodal characteristics (close coupling state) and increases continuously little by little. It is also understood from this result that, when the distance Z is smaller than a value where the critical coupling state is obtained, power can be transferred satisfactorily by optimizing the resonant frequency f3. In the prior art, when the resonant frequency at any distance Z is different from the power transmission frequency in a region of the distance Z which is to have bimodal characteristics, there arises a problem that the output power P of the rectifier circuit 7 decreases; however, the problem can be solved as shown in FIG. 8 according to the present invention.

FIG. 9 is a graph showing the relationship of the resonant frequency f3 at which the output power P of the rectifier circuit 7 in each distance Z becomes maximum, with respect to the distance Z. As shown in FIG. 9, in the vicinity of the distance Z of 50 mm where the critical coupling state is obtained, the resonant frequency f3 changes less due to a small adjustment width of the resonant frequency f3. However, as the distance Z between the power transmission coil 4a and the auxiliary coil 10 becomes small, the resonant frequency f3 has bimodal characteristics and a difference between two resonant frequencies becomes large. Therefore, it is understood that, in order to obtain the maximum output power P, it is necessary to adjust the trimmer capacitor 11a to increase the resonant frequency f3.

As described above, by configuring a transmission side resonant system by adding the transmission power auxiliary device 9, and placing the power receiver in the power receiving space, thereby increasing a possible power transfer distance, power can be transferred stably even when the distance Z between the power transmission coil 4a and the auxiliary coil 10 (power receiving coil 4b) changes. Thus, it is not necessary to provide a number of power transmission coils so as to cope with a change in distance. Further, the resonant frequency of the auxiliary resonator is adjusted in accordance with the distance Z to optimize the receiving power supplied from the power transmitter 1 to the power receiver 2, and hence, power can be transferred stably corresponding to the distance Z even in a distance region shorter than the distance Z in which the critical coupling state is obtained (bimodal characteristics region).

Although the distance a is set to 5 mm in the above-mentioned experiment, the same result is obtained even when the distance a is changed appropriately. For example, only the auxiliary coil 10 and the power receiving coil 4b may be placed at the same position (distance a=0 mm). In this case, cost can be reduced by molding both the coils integrally through use of planar coils so as to reduce thickness. Even in this case, it is necessary to set the diameter of the auxiliary coil 10 to be larger than that of the power receiving coil 4b. That is, planar coils are used as the power receiving coil 4b and the auxiliary coil 10 and placed on the identical plane with the center axes of both the coils being coaxial, and further, the diameter d2 of the power receiving coil 4b and the diameter d3 of the auxiliary coil 10 are set so as to satisfy d2<d3. It is more preferred that an outer diameter do2 of the power receiving coil 4b and an inner diameter di3 of the auxiliary coil 10 be set so as to satisfy do2<di3.

The present embodiment also can be applied to supply of power to an electric automobile. In this case, even when the distance X from the power transmission coil to the power receiving coil varies from the originally set distance X due to a change in the number of people in an automobile, the amount of baggage loaded on the automobile, or an air pressure of a tire, the output power P of the rectifier circuit can be maximized by adjusting the resonant frequency f3 of the power-transmission auxiliary device at the distance X during supply of power to be an appropriate value.

Thus, according to the present invention, even when the distance between the power transmission coil and the power receiving coil changes, power can be transferred stably only by adjusting the adjusting capacitor attached to the auxiliary coil, and further, it is not necessary to provide means for adjusting the resonant frequency in the power receiver and the power transmitter. Therefore, the power transmitter and the power receiver can be reduced in cost.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A wireless power transfer apparatus comprising:
a power transmitter including a power transmission resonator composed of a power transmission coil and a resonant capacitance; and
a power receiver including a power receiving resonator composed of a power receiving coil and a resonant capacitance,
thereby transferring power from the power transmitter to the power receiver through an interaction between the power transmission coil and the power receiving coil,
further comprising: a power-transmission auxiliary device including an auxiliary resonator composed of an auxiliary coil and a resonant capacitance;
a resonance control unit for adjusting a resonant frequency of the auxiliary resonator; and
a linking supporting mechanism for keeping a coil distance between the power receiving coil and the auxiliary coil constant,
wherein the power transmitter and the power-transmission auxiliary device are disposed so as to face each other, forming a power receiving space for disposing the power receiving coil between the power transmission coil and the auxiliary coil, and
the resonance control unit adjusts a resonant frequency of the auxiliary resonator in accordance with a coil distance between the power transmission coil and the auxiliary coil in an axial direction, thereby optimizing receiving power supplied to the power receiver.

2. The wireless power transfer apparatus according to claim 1, wherein power is transferred from the power transmitter to the power receiver through magnetic field resonance between the power transmission coil and the power receiving coil.

3. The wireless power transfer apparatus according to claim 1, wherein the resonance control unit is configured so as to adjust the resonant capacitance of the auxiliary resonator to adjust a resonant frequency of the auxiliary resonator.

4. The wireless power transfer apparatus according to claim 1, comprising a power detection unit for detecting power transferred to the power receiving device,
wherein the resonance control unit is configured so as to adjust the resonant frequency of the auxiliary resonator based on a detection signal of the power detection unit.

5. The wireless power transfer apparatus according to claim 1, comprising a distance detection unit for detecting the coil distance,
wherein the resonance control unit is configured so as to adjust the resonant frequency of the auxiliary resonator based on a detection signal of the distance detection unit.

6. The wireless power transfer apparatus according to claim 1, wherein, in the coil distance in which an electromagnetic coupling state between the power transmission resonator and the auxiliary resonator becomes a close coupling state exhibiting bimodal characteristics, the resonance control unit adjusts a resonant frequency f3 of the auxiliary resonator in a direction in which a resonant frequency ft of a transmission-side resonant system formed by the power transmission resonator and the auxiliary resonator approaches a resonant frequency f2 of the power receiving resonator.

7. The wireless power transfer apparatus according to claim 6, wherein a diameter d1 of the power transmission coil, a diameter d2 of the power receiving coil, and a diameter d3 of the auxiliary coil satisfy the relationship: d1>d2, and d2<d3.

8. The wireless power transfer apparatus according to claim 7, wherein the relationship: d1=d3 is satisfied.

9. The wireless power transfer apparatus according to claim 6, wherein the power receiving coil and the auxiliary coil are planar coils and are placed on an identical plane with center axes of both the coils being coaxial, and further, a diameter d2 of the power receiving coil and a diameter d3 of the auxiliary coil satisfy the relationship: d2<d3.

10. The wireless power transfer apparatus according to claim 6, wherein, in the coil distance in which an electromagnetic coupling state between the power transmission resonator and the auxiliary resonator becomes a close coupling state exhibiting bimodal characteristics, a resonant frequency f1 of the power transmission resonator, the resonant frequency f2 of the power receiving resonator, and the resonant frequency f3 of the auxiliary resonator are set so as to satisfy the relationship: f1=f2<f3, or f3<f1=f2.

11. The wireless power transfer apparatus according to claim 10, wherein the relationship: f0=f1=f2<f3 is satisfied, where f0 represents a resonant frequency of a high-frequency power driver for supplying power to the power transmission coil.

12. A wireless power transfer method using: a power transmitter including a power transmission resonator composed of a power transmission coil and a resonant capacitance, and a power receiver including a power receiving resonator composed of a power receiving coil and a resonant capacitance, thereby transferring power from the power transmitter to the power receiver through an interaction between the power transmission coil and the power receiving coil,
wherein the method further uses a power-transmission auxiliary device including an auxiliary resonator composed of an auxiliary coil and a resonant capacitance, and
the method comprising:
disposing the power-transmission auxiliary device and the power transmitter so as to face each other, forming a power receiving space between the power transmission coil and the auxiliary coil, and performing power transfer with the power receiving coil being disposed in the power receiving space, while keeping a coil distance between the power receiving coil and the auxiliary coil constant, and
adjusting a resonant frequency of the auxiliary resonator in accordance with the coil distance between the power transmission coil and the auxiliary coil in an axial direction, thereby optimizing receiving power to be supplied from the power transmitter to the power receiver.
